(19) United States
(12) Patent Application Publication
(10) Pub. No.: US 2003/0225914 A1
(43) Pub. Date: Dec. 4, 2003

(54) Method for increasing effective bandwidth for links with multiple headers

(75) Inventors: Michael Gazier, Nepean (CA); Tim Jenkins, Kinburn (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Catena Networks, Inc., Redwood Shores, CA

(21) Appl. No.: 10/374,775

(22) Filed: Feb. 24, 2003

(30) Foreign Application Priority Data
Feb. 22, 2002 (CA) 2,373,203

(51) Int. Cl. G06F 15/16

(52) U.S. Cl. 709/247; 709/236; 709/246

(57) ABSTRACT

A method is described for improving bandwidth utilization on point-to-point and point-to-multipoint links, wherein data packets are transmitted across the links in cells. The method includes the following steps. A context is defined comprising a plurality of protocol headers for the data packets. At a transmitter, the protocol headers associated with subsequent data to be transmitted are replaced with a compressed header. At a receiver, the compressed header is used for identifying an associated context. The compressed header is replaced with the plurality of headers in accordance with the associated context. How many of the plurality of protocol headers to be compressed is determined such that header compression achieves a header size reduction equal to or greater than a payload size of the cells, thereby improving bandwidth utilization of the link.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates generally to data communications networks and specifically to a method of improving bandwidth utilization of point-to-point and point-to-multipoint links.

Asynchronous transfer mode (ATM) is a standard protocol for transmitting asynchronous telecommunications data. This protocol is based on the transmission of data in fixed size data packets known as ATM cells. Each ATM cell comprises a 5-byte header and a 48-byte payload. It is well known in the art that ATM is commonly employed as a bearer for transporting data from point to point in a network environment. Typically, the data packets being transported are initially formatted in accordance with any one of a number of different protocols. Examples of such protocols include the transport control protocol (TCP), the user datagram protocol (UDP), and the real-time transport protocol (RTP). The Internet Protocol (IP) protocol uses variable sized packets for transporting data from a origin to a destination. The TCP, UDP, and RTP protocols are responsible for guaranteeing delivery of the packets and ensuring proper sequencing of the data, as well as for providing other services.

However, in order to provide such services, there is often a need for multiple protocol layer headers to be placed in the packets. These headers consume bandwidth, often unnecessarily, and often on a link-by-link basis. The more bandwidth that is occupied by the headers, the less bandwidth is available for actual data transfer.

As a result, a number of methods have been defined for compressing IP, UDP, and TCP headers. For example, Internet Protocol Header Compression (IPHC) describes a method of compressing IP, UDP and TCP headers. IPHC is described in detail by Network Working Group Request for Comments (RFC) 2507, which is hereby incorporated herein by reference. IPHC and other compression methods can save up to 24 bytes from typical packet headers.

However, as previously mentioned, the payload size of an ATM cell is 48 bytes. For data transmitted over an ATM-based system, where all packets are carried in ATM cell payloads, a multiple of 48 bytes (minus 8 bytes in the last cell for the AAL5 trailer) is a critical point for effective packet length changes. Thus, in this case, IPHC is insufficient for any practical bandwidth savings, since only 24 bytes are saved. In order to effectively reduce the bandwidth on an ATM-based system, compression must reduce the number of ATM cells required for the packet transport. That is, at least 40 or 48 bytes should be removed with some regularity to achieve bandwidth savings of any significance.

Therefore, it is an object of the present invention to obviate or mitigate at least some of the above-mentioned disadvantages.

### BRIEF SUMMARY OF THE INVENTION

In accordance with an aspect of the present invention, there is provided a method of improving bandwidth utilization on point-to-point and point-to-multipoint links, wherein data packets are transmitted across the links in cells. The method includes the following steps. A context is defined comprising a plurality of protocol headers for the data packets. At a transmitter, the protocol headers associated with subsequent data to be transmitted are replaced with a compressed header. At a receiver, the compressed header is used for identifying an associated context. The compressed header is replaced with the plurality of headers in accordance with the associated context. How many of the plurality of protocol headers to be compressed is determined such that header compression achieves a header size reduction equal to or greater than a payload size of the cells, thereby improving bandwidth utilization of the link.

In accordance with another aspect of the invention, there is provided a method for improving bandwidth utilization on point-to-point and point-to-multipoint links by reducing header overhead, wherein the overhead is reduced by an amount that is at least as great as a specific payload size related to a corresponding link and transport layer.

### BRIEF DESCRIPTION OF THE DRAWINGS

An embodiment of the invention will now be provided by way of example only with reference to the following drawings in which:

FIG. 1 is a block diagram of a portion of a telecommunication system for utilizing header compression;

FIG. 2 is a flowchart of a method according to one embodiment of the present invention; and

FIG. 3 is a flowchart of a method according to another embodiment of the present invention.

### DETAILED DESCRIPTION OF THE INVENTION

For convenience, like numerals in the description refer to like structures in the drawings. Between ATM and IP, there may be multiple protocol layers, often considered to be at layer-2, that have to be placed into packets, in addition to the IP headers. Examples of such protocol layers include Point-to-Point Protocol (PPP), Point-to-Point Protocol over Ethernet (PPPoE), and Multi-Protocol over Asynchronous Transfer Mode (MPOA). PPP is described in detailed by RFC 1661. Similarly, PPPoE is described in detail by RFC 2516, and MPOA is described in detail by RFC 1483 and RFC 2684. (Note that the concepts of this patent can be generalized to other layers.)

Depending on the encapsulation method chosen from the MPOA layer, the total overhead for the headers, including TCP, UDP and IP, can be over 54 bytes, which often exceeds the payload portion of the packet. Further, when used over ATM, this overhead also often exceeds the payload portion of a cell. Although the TCP, UDP, and IP headers can be compressed, there can be as many as 32 bytes in the headers below IP for a typical PPPoE Digital Subscriber Loop (xDSL) customer.

Header compression is applied to protocols between IP and ATM for increasing IPHC's savings of 24 bytes in order to reduce the number of cells per packet over ATM links. Specifically, the method described herein, combined with IPHC, can reduce by one the number of ATM cells required for every packet. Further, whether used with or without IPHC, this technique can provide bandwidth savings on other point-to-point links, even when ATM is not the physical layer protocol of choice.

In examining a typical xDSL connection, the protocols used between IP and ATM include PPP, PPPoE, Ethernet/802.3, and MPOA, whose headers consume 2 bytes, 6 bytes, 14-17 bytes, and 10 bytes (using Logical Link Control (LLC)/Sub-Network Access Protocol (SNAP) encapsulation), respectively. Typically, ATM Application Layer 5 (AAL5) encapsulation is used to carry a packet on ATM cells. If the concepts of header compression are applied to this set of protocols on a link-by-link basis, the 32 bytes of total headers can be replaced by as few as 2 bytes of header. This compression results in a net savings of up to 30 bytes of header for the bulk of a user's traffic. Note that the AAL5 layer is not compressed for two reasons. First, the AAL5 layer is maintained so as not to disturb the ATM equipment's handling of the packet. Second, a number of the fields removed from the headers are length fields. The length fields' values are inferred from other protocol layers, and can be taken from the AAL5 layer.

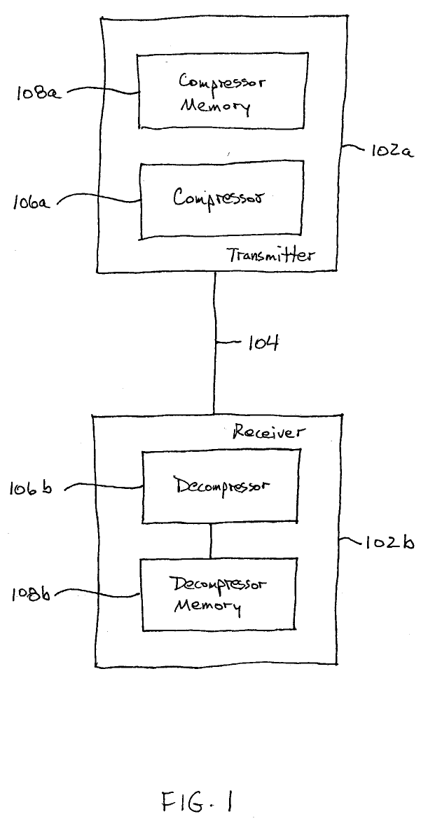

A header compression system employing this compression technique is described as follows. Referring to FIG. 1, a portion of a telecommunication system is illustrated generally by numeral 100. The system comprises two entities 102a and 102b connected by a point-to-point link 104. Each of the entities 102a and 102b further comprises a processor 106a or 106b and a memory 108a or 108b. For ease of explanation, only transmission of data from a transmitting entity 102a to a receiving entity 102b will be described. In such a case, the processor 106a and the memory 108a associated with the transmitting entity 102a are referred to as the compressor 106a and the compressor memory 108a, respectively. The processor 106b and the memory 108b associated with the receiving entity 102b are referred to as the decompressor 106b and the decompressor memory 108b, respectively.

In the present embodiment, ATM cells are carried by the link 104. The compressor 106a creates a context for the ATM cells to be transmitted. The context is a state that the compressor uses to compress a header and that the decompressor uses to decompress a header. The context is the uncompressed version of the last header transmitted over the link, and comprises data unique to a packet. For example, the headers for protocols listed in the present embodiment are defined as follows, in Table 1.

TABLE 1

| | | Header Size | |
|---|---|---|---|
| Protocol | Header | (bytes) | Definition |
| PPP | protocol | 2 | NOCHANGE (DEF) |
| PPPoE | ver | 4 | NOCHANGE (DEF) |
| | type | 4 | NOCHANGE (DEF) |
| | code | 1 | NOCHANGE (DEF) |
| | session ID | 2 | NOCHANGE (DEF) |
| | length | 2 | INFERRED |
| Ethernet | dest | 6 | DELTA (DEF) |
| | src | 6 | NOCHANGE (DEF) |
| | type | 2 | NOCHANGE (DEF) |
| 802.3 | dest | 6 | DELTA (DEF) |
| | src | 6 | NOCHANGE (DEF) |
| | length | 2 | INFERRED |
| | DSAP, SSP, CTL | 3 | NOCHANGE (DEF) |
| RFC 1483 | LLC | 3 | NOCHANGE |
| LLC | OUI | 3 | NOCHANGE |
| multiplexing | PID | 2 | NOCHANGE (DEF) |
| | pad | 2 | NOCHANGE |
| RFC 1483 | pad | 2 | NOCHANGE |
| VC | | | |
| multiplexing | | | |

The definitions DELTA, NOCHANGE, and INFERRED are used to describe how the header fields for each of the protocols are defined for a given context. DELTA refers to fields that change in a predefined manner from packet to packet associated with the same context. As a result, rather than sending the new header, only an indicator is transmitted, which is used determining which header to apply to the packet. Thus it is “cheaper” to transmit the indicator rather than the actual header, since the indicator uses less overhead. For example, in the present embodiment, only the destination fields for the 802.3 and the Ethernet headers are defined by DELTA. For these fields, it is possible that the destination is either an address defined in the specific context or a broadcast address. As a result, each packet specifies which of the addresses to transmit to using a single bit code. If the bit is a zero, the context-specific address is selected. If the bit is a one, the broadcast address is selected. Alternately, if the bit is a one, the context-specific address is selected and if the bit is a zero, the broadcast address is selected.

NOCHANGE (DEF) refers to fields that are constant within each packet for a specific compression context. Therefore, headers defined by this field may have different values for different contexts. For example, as listed above, such types of fields include version, type, source, and code for the PPPoE headers. NOCHANGE refers to fields that are constant within each packet for all contexts. For example, other than the PID field, all fields used for LLC encapsulation have a constant value, since the headers are the same regardless of the PID used. The PID is defined as NOCHANGE (DEF), since its value depends on the protocol used and may differ from context to context.

INFERRED refers to fields whose values can be determined from somewhere else, normally from another protocol layer of the packet or from other fields in the header for a specific protocol layer. For example, field length is contained in the AAL5 layer, which is not compressed and thus can simply be retrieved.

As previously described, the compressor 106a creates the contexts based on characteristics of the packets flowing over the link 104. The context is transmitted to the decompressor 106b, which stores the context in the decompressor memory 108b. The compressor 106a then replaces the following packets with corresponding compressed versions of the same packets. In place of the standard headers, the compressed header is used. The compressed header includes a context identifier (CID) for identifying the context with which it corresponds. Further, the compressed header includes representations of the fields defined as DELTA headers. As a result, the compressed header comprises two bytes, thus significantly reducing header overhead. However, it may also be feasible to reduce the header to a single byte. Typically, the compressed header size depends on the number of contexts to be supported as well as the number of bits required for specifying the DELTA fields that are not implicit. Once the decompressor 106b receives a packet, it uses the CID for identifying the corresponding context, retrieves the context from the decompressor memory 108b, and reconstructs the original header accordingly.

Creating and managing the appropriate contexts allows the use of any combination of the protocols. New protocol types for the ATM encapsulation (AAL5) are defined to indicate the new “protocols” that are introduced. These include headers for transmitting compressed data packets, packets for creating and deleting contexts, and packets for updating existing contexts.

Note that a single context is used for all protocols below IP, and this context is not bound to the IPHC context. As a result, the context for the protocols below IP is independent of the context for the protocols above IP. This allows other higher layer header compression techniques to be developed independently of this compression technique. It also allows compression techniques other than IPHC to be used for the higher layer compression. Further, it is likely for a given user that there will be fewer layer 2 compression contexts than there will be IP and higher layer contexts. More specifically, all headers below IP when used for digital subscriber loop (DSL) over ATM are identical. As a result, for each point-to-point link, typically only one context is necessary.

When using a link technology, such as ATM, that has fixed length cells or frames, the effective bandwidth savings depends on the distribution of traffic. For example, when the compression technique described above is used over ATM and traffic distribution of packet lengths 82, 568 and 1500 bytes as a percentage of packets is 50, 30 and 20 percent, respectively, the effective bandwidth savings exceed 10%. Thus, it can be seen that the greater the percentage of short packets, the greater the effective bandwidth savings due to the increased number of packets that use fewer ATM cells. Therefore, the compression technique described herein in particularly useful for links carrying a relatively large number of short packets. Voice over IP (VoIP) communication is one example of an application that will typically comprise short packets. Further, the compression technique is especially useful for slow links.

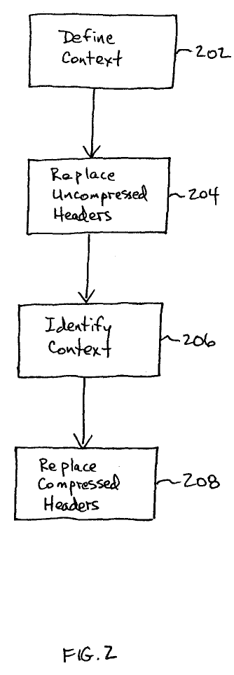

FIG. 2 is a flowchart of a method according to one embodiment of the present invention. (Further details regarding this method are described above.) In this embodiment, data packets are transmitted across a link in cells. In step 202, a context comprising protocol headers for the data packets is defined. In step 204, at the transmitter, the protocol headers associated with subsequent data to be transmitted are replaced with a compressed header. In step 206, at the receiver, the compressed header is used to identify an associated context. In step 208, the compressed header is replaced with the protocol headers in accordance with the associated context. How many of the protocol headers to be compressed is determined such that header compression achieves a header size reduction equal to or greater than a payload size of the cells, thereby improving bandwidth utilization.

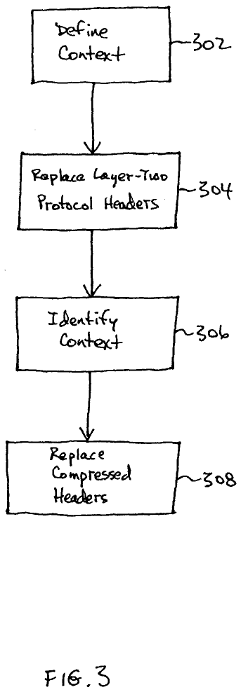

FIG. 3 is a flowchart of a method according to another embodiment of the present invention. (Further details regarding this method are described above.) In step 302, a context is defined that comprises layer-two protocol headers for layer-two protocols. In step 304, at the transmitter, the layer-two protocol headers associated with subsequent data to be transmitted are replaced with a compressed header. In step 306, at the receiver, the compressed header is used to identify an associated context. In step 308, the compressed header is replaced with the layer-two protocol headers in accordance with the associated context.

In an alternate embodiment, instead of setting up the destination field for the 802.3 and Ethernet protocols as DELTA, the fields can be set up as NOCHANGE (DEF). However, for such a setup, different contexts need to be set up for address specific destinations, broadcast destinations, and multicast destinations.

Further, while the above description refers specifically to ATM as the link architecture, a person skilled in the art will appreciate that the concept can be applied to other link technologies. An important feature of the invention is that the compression scheme provides an overhead reduction that is greater than a payload size for at least one cell. This provides useful header compression for achieving an actual increase in effective line rate. That is, for example, if the header compression saves one payload cell, then for each packet one less cell is transmitted. As a result, there is an effective bandwidth saving of one cell for each packet. As previously described, this savings is particularly useful for a large number of short packets, since it can be seen that bandwidth savings will increase dramatically.

Yet further, for variable length transmission media, the effective bandwidth savings do not depend on crossing the thresholds of frame sizes. Note that the concepts described herein with respect to IPHC can also be generalized to other protocols of a similar nature or similar goal.

Although the invention has been described with reference to certain specific embodiments, various modifications thereof will be apparent to those skilled in the art without departing from the spirit and scope of the invention as outlined in the claims appended hereto.

What is claimed is:

1. A method of improving bandwidth utilization on a link, wherein said link is one or more of point-to-point and point-to-multipoint links, wherein a plurality of data packets are transmitted across said links in cells, said method comprising the steps of:
defining a context comprising a plurality of protocol headers for said plurality of data packets;
replacing, at a transmitter, said plurality of protocol headers associated with subsequent data to be transmitted with a compressed header;
using, at a receiver, said compressed header for identifying an associated context; and
replacing said compressed header with said plurality of protocol headers in accordance with said associated context,
wherein how many of said plurality of protocol headers to be compressed is determined such that header compression achieves a header size reduction equal to or greater than a payload size of said cells, thereby improving bandwidth utilization of said link.

2. A method as defined in claim 1, wherein said link is an asynchronous transfer mode (ATM) link.

3. A method as defined in claim 2, wherein said payload size is 48 bytes.

4. A method as defined in claim 1, wherein said compressed header includes a context identifier.

5. A method as defined in claim 4, wherein said compressed header further includes data relating changes in predefined headers for a given context.

6. A method of improving bandwidth utilization on a link, wherein said link is one or more of point-to-point and point-to-multipoint links, by reducing header overhead, said method comprising the steps of:
defining a context comprising a plurality of layer-two protocol headers for a plurality of layer-two protocols;
replacing, at a transmitter, said plurality of layer-two protocol headers associated with subsequent data to be transmitted with a compressed header;
using, at a receiver, said compressed header for identifying an associated context; and
replacing said compressed header with said plurality of layer-two protocol headers in accordance with said associated context.

7. The method as defined in claim 6, wherein said subsequent data is transmitted in packets.

8. The method as defined in claim 7, wherein said packets are transmitted in cells over said link.

9. The method as defined in claim 8, wherein said header overhead is reduced such that a total overhead reduction is greater than a payload size of a cell, thereby improving bandwidth utilization of said link.

10. A method as defined in claim 9, wherein said link is an asynchronous transfer mode (ATM) link.

11. A method as defined in claim 10, wherein said payload size is 48 bytes.

12. A method as defined in claim 6, wherein said compressed header includes a context identifier.

13. A method as defined in claim 12, wherein said compressed header further includes data relating changes in predefined headers for a given context.
